(19) United States
(12) Patent Application Publication
(10) Pub. No.: US 2006/0090199 A1
(43) Pub. Date: Apr. 27, 2006

(54) Network management system and data sharing method thereof

(75) Inventor: Akihiro Okano, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/248,004

(22) Filed: Oct. 12, 2005

(30) Foreign Application Priority Data
Oct. 13, 2004 (JP) P2004-299453

(51) Int. Cl. H04L 9/32

(52) U.S. Cl. 726/6

(57) ABSTRACT

A network management system includes a network management equipment (a video display equipment) having a server function and at least one terminal (a participant terminal) are network-connected. The network management equipment (the video display equipment) has a common key code used to authenticate a connection to a network. The network management system has a common key code device into which the common key code can be loaded, and then a user's terminal can be connected to the network by installing a common key code device (an Universal Serial Bus memory) into the user's terminal.

### BACKGROUND OF THE INVENTION

1. Field of the Invention

The present invention relates to a network management system and a data sharing method and, more particularly, a network management system used in an electronic conference system and a data sharing method for use in this system.

2. Description of the Related Art

As the electronic conference system in a related art, there is known the system that can register and manage a reservation of the on-line conference room to improve a utilization efficiency and a security of the on-line conference room (see JP-A-2004-21501, for example), the system that can prevent the unrelated terminal from entering into the radio network (see JP-A-2004-96495, for example), or the system that can utilize the mobile memory device to carry on smoothly the conference using the electronic materials (see JP-A-2004-173180, for example).

Also, as the system for sharing the data via the network, there is proposed the system in which the operation applied to the data file at one user's terminal can be reflected in the data file at the other user's terminal to make the transfer of information precisely and quickly (see JP-A-2004-145539, for example).

### SUMMARY OF THE INVENTION

In holding an electronic conference while looking at a relatively large video display equipment set up in the base of the electronic conference, sometimes the participants who take part in this conference discuss while keeping the notebook PC (personal computer), or the like as their own terminals at hand.

In the electronic conference system in the related art, respective participants could not get the data displayed on the video display equipment in conference and save such data in their own terminals (notebook PCs, or the like), and also could not load the data onto the video display equipment from their own terminals. Therefore, respective participants who took part in the conference could not share the data, etc. used in the conference. In order to make the transfer of data, each participant must copy the data once from his or her own terminal to the magnetic memory device, the memory card, or the like. As a result, there existed the problems that it takes much time and labor to make the transfer of data and thus the direction of the meeting is greatly broken off, and the like.

In contrast, in order to connect the electronic conference system connected to the video display equipment and the terminal (PC, or the like) via a network the security of which is guaranteed, it may be considered that the terminals, networks of which are set to be connected to the electronic conference system respectively, are prepared and registered in the database of the electronic conf erence system and then the data sharing can be realized among these registered terminals only.

However, it is difficult for the participant, who intend to take part in the conference while bringing the notebook PC, or the like that has not been registered yet in the database of the electronic conference system, to set up temporarily easily a closed network the security of which is guaranteed only when these participants are taking part in the conference.

It is an object of the invention to provide a network management system capable of executing a transfer of data between any users safely and simply by setting up temporarily a closed network the security of which is guaranteed and a data sharing method for use in this system.

According to an aspect of the invention, there is provided with a network management system including: a network management equipment having a server function; and at least one terminal are network-connected, wherein the network management equipment has a common key code to authenticate a connection to a network, the network management system has a common key code device into which the common key code can be loaded, and wherein a user's terminal can be connected to the network by installing the common key code device into the user's terminal.

According to another aspect of the invention, there is provided with a network management system for an electronic conference system including: a network management equipment having a server function; and at least one terminal are network-connected, wherein the network management equipment has a common key code to authenticate a connection to a network of the electronic conference system, the network management system has a common key code device into which the common key code can be loaded, and a user's terminal can be connected to the network of the electronic conference system as a participant terminal by installing the common key code device into the user's terminal.

According to another aspect of the invention, there is provided with a data sharing method of network-connecting a network management equipment having a server function and at least one terminal to share data via the network management equipment, including: loading a common key code, which is used to authenticate a connection to a network, from the network management equipment to a common key code device; rewriting a network setting of a user's terminal to a setting corresponding to the network, by reading the common key code from the common key code device installed into the user's terminal; and connecting the user's terminal to the network based on the rewritten network setting of the user's terminal.

According to another aspect of the invention, there is provided with a data sharing method in an electronic conference system that network-connects a network management equipment having a server function and at least one terminal to share data via the network management equipment, including: loading a common key code, which is used to authenticate a connection to a network of the electronic conference system, from the network management equipment to a common key code device; rewriting a network setting of a user's terminal to a setting corresponding to the network of the electronic conference system, by reading the common key code from the common key code device installed into the user's terminal; and connecting the user's terminal to the network of the electronic conference system based on the rewritten network setting of the user's terminal.

### BRIEF DESCRIPTION OF THE DRAWINGS

FIG. 1 is a schematic view showing a configuration of a network management system according to an embodiment of the present invention.

FIG. 2 is a schematic view explaining how to network-connect a user's terminal to the network management system according to the embodiment of the present invention.

FIG. 3 is a flowchart showing an operation of the user's terminal in the embodiment of the present invention to execute the network-connection to a video display equipment.

FIG. 4 is a flowchart showing an operation of a common key registering process in the embodiment of the present invention.

### DESCRIPTION OF THE PREFERRED EMBODIMENTS

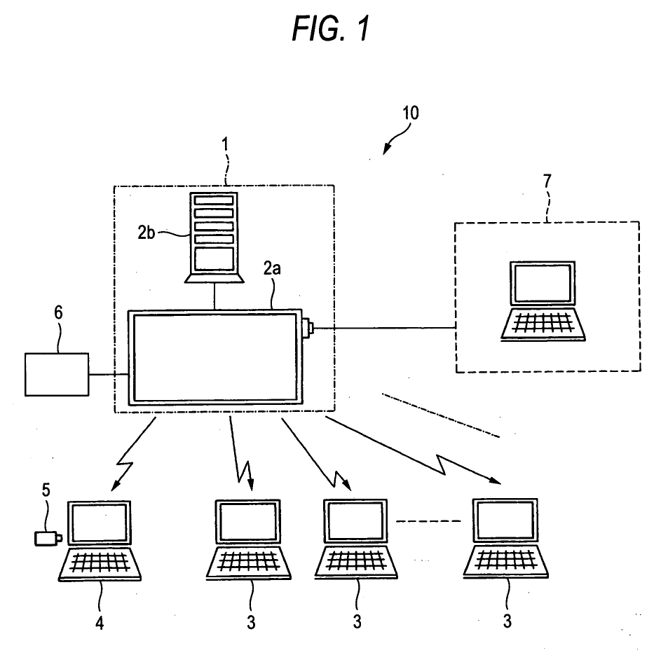

A network of an electronic conference system and a data sharing method according to an embodiment of the present invention will be explained in detail with reference to the drawings hereinafter. FIG. 1 is a schematic view showing a configuration of a network management system according to the embodiment of the present invention.

As shown in FIG. 1, a network management system 10 includes a video display equipment 1 having a video display portion 2a and a server 2b, participant terminals 3 that have already sat in on the conference, a user's terminal 4 that is going to take part newly in the electronic conference, an input device 6, and a participant terminal 7 located at a remote place.

The network management system 10 provides a network management system for use in the electronic conference system in which the network management equipment (the video display equipment 1) having a server function and at least one participant terminal 3 are connected via a network. The network management equipment (the video display equipment 1) has a common key code to authenticate the connection to the network of the electronic conference system. Also, a common key code device (a USB (Universal Serial Bus) memory 5) into which the common key code can be loaded is provided. When the common key code device (the USB memory 5) is installed into the user's terminal 4, this user's terminal 4 is connected to the network of the electronic conference system as the participant terminal 3.

As shown FIG. 1, the video display equipment 1 has a server function because such system contains the server 2b connected to the video display portion 2a. The server 2b may not be built in the same as the video display equipment 1, but may be configured as a separate body respectively.

In an example shown in FIG. 1, the participant terminal 3 is network-connected to the video display equipment 1 via a radio communication. But the participant terminal 3 may be network-connected to the video display equipment 1 via a cable communication. The participant terminal 3 may include the terminal that has an IP address registered in the database of the network management system 10, or may include the terminal into which the USB memory 5, into which the common key code has already been loaded, has already been installed.

Then, when the USB memory 5 as the common key code device, into which the common key code has already been loaded to authenticate the conference participation, is installed into the user's terminal 4, the user's terminal 4 that intends to participate newly in the network management system 10 can be network-connected as the new conference terminal via the video display equipment 1.

In addition, the network management system 10 has the input device 6 used to input the data, the set information, etc. into the video display equipment 1. The participant terminal 7 located at the remote place that is away from the place in which the video display equipment 1 is set up, and the like may be connected via a cable network.

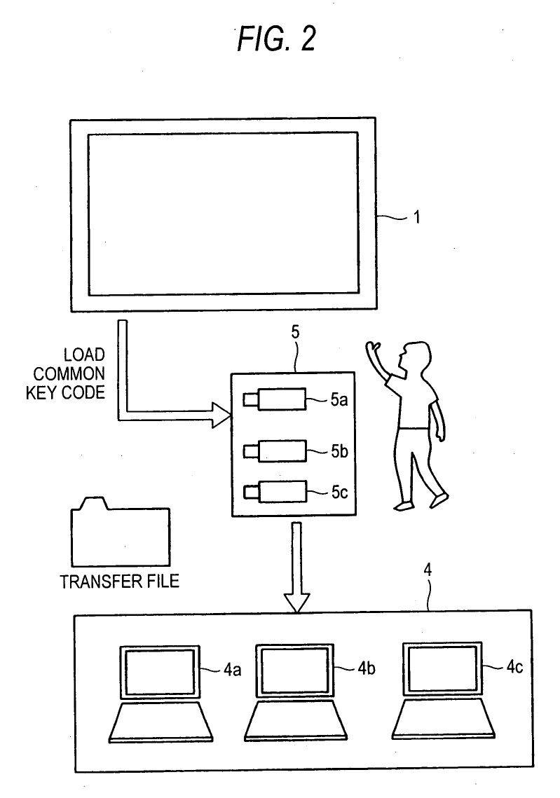

FIG. 2 is a schematic view explaining how to network-connect the user's terminal 4 to the network management system 10 according to the embodiment of the present invention. The video display equipment 1 is configured by a PDP (Plasma Display Panel) as a relatively large display device of a PC (personal computer) built-in type, for example. In an example shown in FIG. 2, the PC built in the plasma display panel has a function of the above server 2b. In this case, the video display equipment 1 may be configured by the display device except the plasma display panel, and also may be configured by other display system such as the liquid crystal display, the EL panel, the CRT, or the like.

The common key code peculiar to the video display equipment 1 is set in this video display equipment 1. A plurality of common key codes may be set to allow a plurality of participants to take part in the electronic conference. For example, in the example shown in FIG. 2, three common key codes are set and three participants can take part in the electronic conference.

When three common key codes are loaded into the USB memory 5 (5a, 5b, 5c) shown in FIG. 2 respectively, the possessors of the USB memories 5a, 5b, 5c can obtain the qualifications for the electronic conference. Then, the participants can take part in the electronic conference by connecting the USB memory 5 (5a, 5b, 5c), into which the common key code is loaded, to the user's terminal 4 (4a, 4b, 4c) respectively.

In the network management system 10 according to the present embodiment, since the USB memory 5 is employed as the common key code device, the user's terminal 4 (PC) that intends to take part newly in the electronic conference can be dynamically connected to the network of the network management system 10 only by inserting the USB memory 5 into its own USB slot. In this case, the PC for exclusive use in the network management system 10 is not needed as the user's terminal 4, and the general-purpose PC can be used as the user's terminal 4.

The new user's terminal 4 can be connected dynamically to the network of the network management system 10. Therefore, the user's terminal 4 (4a, 4b, 4c) can share the data with other participant terminals 3, which have already sat in on the electronic conference, and the participant terminal 7 located at the remote place (see FIG. 1) via the server 2b, and also can transmit/receive the file to/from them.

In the related art, it is difficult to build up dynamically the closed network of the user's terminal 4 (the general-purpose PC, or the like) that is going to participate newly in the electronic conference. In contrast, as described above, the network management system 10 makes it possible to build up easily the closed network of the new user's terminal 4.

According to the network management system 10, it is feasible to build up the system through which any participants who take part in the electronic conference can execute safely and simply the transfer of the data (file).

In the above network management system, the peculiar common key code is set previously in the video display equipment 1, and then the USB memory 5 into which this common key code is loaded is used as the common key code device. Therefore, there is no necessity to employ the special-purpose device, or the like as the common key code device.

In loading the common key code into the USB memory 5, the set information such as the time of validity, the term of validity, or the like of the common key can also be set. Thus, the system the high security of which is guaranteed can be built up.

In the network management system 10 according to the present embodiment, the closed network can be simply built up temporarily. At that time, it is decides whether a change of the setting of the network can be approved or not when the common key of the authorized USB memory 5 is inserted into the user's terminal (PC). Then, if such change of the setting can be approved, the network to be connected to the network management system 10 can be built up. Then, the transfer of data can be executed among the networks built up in this way via the server 2b of the video display equipment 1.

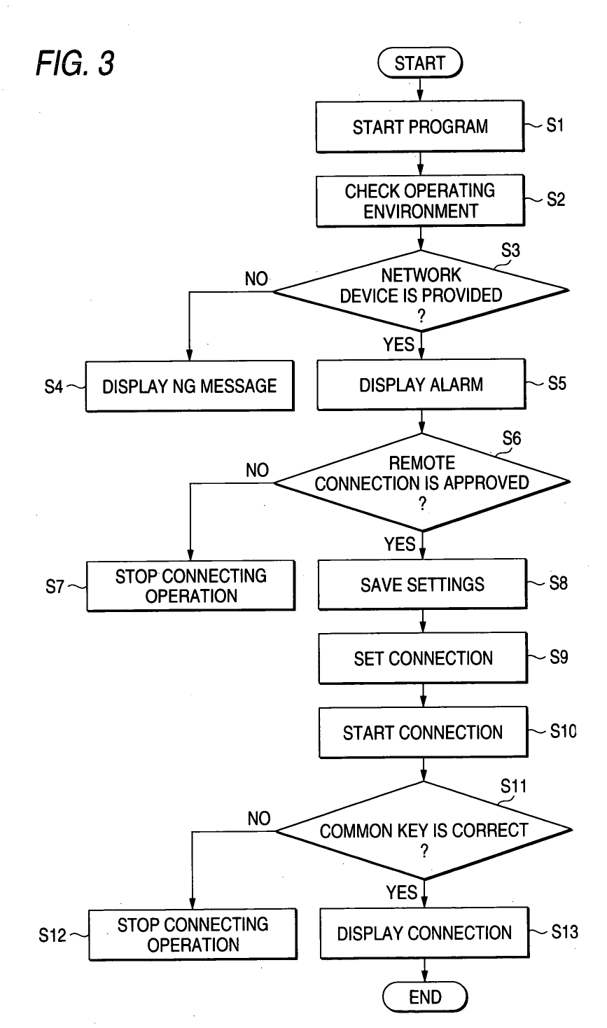

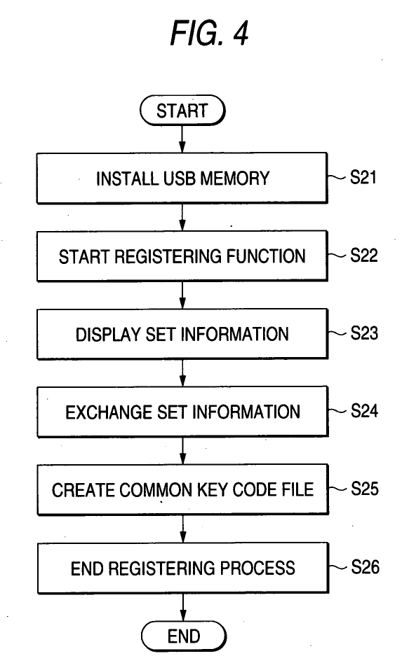

Next, an operation of a data sharing method in the network management system 10 will be explained with reference to flowcharts in FIG. 3 and FIG. 4 hereunder. First, an operation of the user's terminal 4 to execute the network-connection to the video display equipment 1 will be explained with reference to a flowchart in FIG. 3 hereunder.

When the USB memory 5 (5a, 5b, 5c) is inserted into the user's terminal 4 (4a, 4b, 4c) (see FIG. 2), a program in the network management system 10 is started automatically (step S1). Then, the operating environments such as OS, and the like are checked (step S2).

Also, it is checked whether or not the network device (e.g., a LAN card, or the like) for a radio communication or a cable communication is providedto the user's terminal 4 (step S3). If the network device is not provided (No), the network connection cannot be set up and then an NG message is displayed on a display screen of the user's terminal 4 (step S4). Thus, the user is informed that the user's terminal 4 cannot be connected to the network management system 10.

If the network device is provided (Yes), the user's terminal 4 can be network-connected to the video display equipment 1. Thus, the process goes to next step S5.

In step S5, an alarm display (warning) is given on the display screen of the user's terminal 4. Thus, the user is informed that the existing network settings that have already been set in the user's terminal 4 is changed from now.

Then, the request is issued to decide whether or not an approval of a change of the existing network settings and also an allowance for a remote connection to the video display equipment 1 are approved (step S6).

In step S6, if an approval of a change of the existing network settings and also an allowance for a remote connection to the video display equipment 1 are not approved (No), the user's terminal stops the connecting operation (step S7). In contrast, if an approval of a change of the existing network settings and also an allowance for a remote connection to the video display equipment 1 are not approved (Yes), the user's terminal saves the existing network settings (step S8).

Then, the connection settings to the video display equipment 1 are executed (step S9). In step S9, the setting of the network, the setting of TCP/IP, the port open of the video display equipment 1, etc. are executed.

Then, when the above connection settings are completed, the network-connection to the video display equipment 1 is started (step S10). Then, it is checked in the beginning of the connection whether or not the common key code is correct (step S11). If the common key code is not correct (No), the user's terminal stops the connecting operation (step S12).

If the common key code is correct (Yes), a message of “You succeeded in connection”, or the like is displayed on the display screen of the user's terminal 4 and also IP address, host name, etc. after the connection are displayed (step S13).

When the network-connection to the video display equipment 1 is completed, the user's terminal 4 is connected to the server 2b of the video display equipment 1 by starting the browser, and thus the data sharing can be realized.

Then, the download or upload of the data to or from the server 2 can be executed appropriately by using a function of the browser.

In this case, a screen requesting the input of the password may be displayed further in the stage at which the browser is started. Then, if the correct password is not input, the network connection may be shut down. Accordingly, the system having the higher security can be built up.

Next, an operation of a common key registering process will be explained with reference to a flowchart shown in FIG. 4 hereunder. First, the USB memory 5 is inserted into the USB slot of the video display equipment 1 (step S21). Then, a common key registering process function of the server 2b is started by starting the browser in this inserted state (step S22).

After started, respective set information in the common key registering process are displayed (step S23). As the setting information, there are the IP address for the participant terminal, the IP address of the video display equipment 1, the MAC address and the SSID (Service Set Identifier) of the video display equipment 1, the WEP (Wired Equivalent Privacy), and the like, and data input and change of respective information are executed.

Then, the set information is exchanged between the video display equipment 1 and the USB memory 5 (step S24). The IP address for the participant terminal and the SSID are transmitted from the video display equipment 1 to the USB memory 5. The common cipher key (the serial number, or the like of the USB memory) is encrypted and transmitted from the USB memory 5 to the video display equipment 1.

After the mutual data transmission is ended, a common key code file is created (step S25). This file is saved in the USB memory 5. Then, amessage “Please pull out the USB memory because the registration has been completed” is displayed, and then the browser is ended by pulling out the USB memory 5. Accordingly, the common key registering process is ended (step S26).

The common key code is loaded into the USB memory 5 by the above common key registering process, and then the USB memory 5 can be used as the common key code device.

In the above embodiment, an example in which the network corresponds to the network of the electronic conference system is shown. However, if the object of the invention can be achieved, the above network can be applied to other systems such as the system in which the video display equipment as the network management equipment corresponds to the electronic blackboard used solely, or the like, for example.

As described in detail, the network management system according to the embodiment of the present invention provides the network management system 10 in which the network management equipment (the video display equipment 1) having the server function and at least one terminal (the participant terminal 3) are network-connected. Then, the network management equipment (the video display equipment 1) has the common key code used to authenticate the connection to the network. Also, the network management system has the common key code device into which the common key code can be loaded, and then the user's terminal 4 can be connected to the network by installing the common key code device (the USB memory 5) into the user's terminal 4. As a result, the closed network the security of which is guaranteed can be built up temporarily, and the transfer of the data can be executed safely and simply among any users.

Also, the data sharing method provides the data sharing method of network-connecting the network management equipment (the video display equipment 1) having the server function and at least one terminal (the participant terminal 3) to share the data via the network management equipment (the video display equipment 1). There are includes loading the common key code, which is used to authenticate the connection to the network, from the network management equipment (the video display equipment 1) to the common key code device (the USB memory 5), rewriting the network setting of the user's terminal 4 to the setting corresponding to the network, by reading the common key code from the common key code device (the USB memory 5) installed into the user's terminal, and connecting the user's terminal 4 to the network based on the rewritten network setting of the user's terminal 4. As a result, the closed network the security of which is guaranteed can be built up temporarily, and the transfer of the data can be executed safely and simply among any users.

What is claimed is:

1. A network management system, comprising:
a network management equipment having a server function; and at least one terminal are network-connected, wherein the network management equipment has a common key code to authenticate a connection to a network,
wherein the network management system has a common key code device into which the common key code can be loaded, and
wherein a user's terminal can be connected to the network by installing the common key code device into the user's terminal.

2. A network management system according to claim 1, wherein the common key code device is an Universal Serial Bus memory.

3. A network management system according to claim 1, wherein a term of validity of the common key code is previously set.

4. A network management system, according to claim 1, wherein the user's terminal is connected to the network via at least one of a radio communication and a cable communication.

5. A network management system according to claim 1, wherein the network management equipment is a video display equipment having a video displaying unit.

6. A network management system for an electronic conference system, comprising:
a network management equipment having a server function; and at least one terminal are network-connected, wherein the network management equipment has a common key code to authenticate a connection to a network of the electronic conference system,
the network management system has a common key code device into which the common key code can be loaded, and
a user's terminal can be connected to the network of the electronic conference system as a participant terminal by installing the common key code device into the user's terminal.

7. A network management system for an electronic conference system according to claim 6, wherein the common key code device is an Universal Serial Bus memory.

8. A network management system for an electronic conference system according to claim 6, wherein a term of validity of the common key code is previously set.

9. A network management system for an electronic conference system according to claim 6, wherein the user's terminal is connected to the network via a radio communication or a cable communication.

10. A network management system for an electronic conference system according to claim 6, wherein the network management equipment is a video display equipment having a video displaying unit.

11. A data sharing method of network-connecting a network management equipment having a server function and at least one terminal to share data via the network management equipment, comprising:
loading a common key code, which is used to authenticate a connection to a network, from the network management equipment to a common key code device;
rewriting a network setting of a user's terminal to a setting corresponding to the network, by reading the common key code from the common key code device installed into the user's terminal; and
connecting the user's terminal to the network based on the rewritten network setting of the user's terminal.

12. A data sharing method in an electronic conference system that network-connects a network management equipment having a server function and at least one terminal to share data via the network management equipment, comprising:
loading a common key code, which is used to authenticate a connection to a network of the electronic conference system, from the network management equipment to a common key code device;
rewriting a network setting of a user's terminal to a setting corresponding to the network of the electronic conference system, by reading the common key code from the common key code device installed into the user's terminal; and
connecting the user's terminal to the network of the electronic conference system based on the rewritten network setting of the user's terminal.
